(19) United States
(12) Patent Application Publication
(10) Pub. No.: US 2003/0155832 A1
(43) Pub. Date: Aug. 21, 2003

(54) Concentric electric motor additive speed drive

(76) Inventor: Gerald R. Herren, Baxter, TN (US)

Correspondence Address: WILSON ENTERPRISES, 2333 BRIGHTON FARMS BLVD., KNOXVILLE, TN, 37932, US

(21) Appl. No.: 10/077,165

(22) Filed: Feb. 16, 2002

(51) Int. Cl. H02K 7/20

(52) U.S. Cl. 310/112

(57) ABSTRACT

An electric motor additive speed drive assembly comprising at least two incrementally increasing diameter electric motors mounted in an integrated concentric manner along a common axis such that the speed and horsepower of the assembly output shaft is the sum of the speed and horsepower of the energized electric motors in the assembly. At least one set of electrically conductive end bearings spans the annular space between the casings of each motor in the assembly allowing the stators of each internal motor to rotate. Electricity is conducted to each inner motor through the electrically conductive end bearings.

### FIELD OF THE INVENTION

This invention relates generally to electric motor drives and, more particularly, to an assembly of incrementally increasing diameter electric motors mounted in an integrated concentric manner along the same axis such that the speed and horsepower of the assembly output shaft is the sum of the speed and horsepower of the individual electric motors in the assembly. The stators of each internal motor rotate. Electricity is conducted to inner motors through electrically conductive end bearings.

### BACKGROUND OF THE INVENTION

Electric motor drive assemblies are used in many industries to convert electrical energy into mechanical energy and drive a rotating output shaft. The output speed can be continuously variable, incrementally variable (stepped), or fixed depending on the arrangement and components of the drive assembly. Geared transmissions can also be used in conjunction with the drive to produce the desired output speed from an electric drive.

Speed changers, also referred to as transmissions, are used in most industrial equipment to alter the output speed of a drive assembly. Electrical, mechanical, and electro-mechanical drives are common. Variable pitch sheaves, gear assemblies, and hydraulic drives are some examples of mechanical type drives. Electrical type drives include variable frequency inverters, variable voltage inverters, variable current inverters, and many specialized inverters for varying electrical power characteristics in the drive. These electrical drives require intricate switching topographies with complicated and expensive construction.

Many techniques have been utilized for varying speed of the output shaft in electric motor drives. U.S. Pat. No. 5,216,339 to Skybyk teaches a lateral DC motor wherein multiple fixed stators are used to rotate a disk rotor and generate additional torque. U.S. Pat. No. 5,982,074 to Smith et al. teaches an axial field motor/generator with fixed stators and annular disc rotors. U.S. Pat. No. 6,252,331 to Mildice et al. teaches a two-phase rotor with fixed windings magnetically coupled to pole pieces that rotate.

Other electric motor drive designs have been used in the past but none teach an assembly of incrementally increasing diameter electric motors mounted in an integrated concentric manner along a common axis such that the speed and horsepower of the assembly output shaft is the sum of the speed and horsepower of the individual electric motors having rotating stators.

### BRIEF SUMMARY OF THE INVENTION

An electric motor additive speed drive assembly comprising at least two incrementally increasing diameter electric motors mounted in an integrated concentric manner along a common axis such that the speed and horsepower of the assembly output shaft is the sum of the speed and horsepower of the energized electric motors in the assembly. At least one set of electrically conductive end bearings spans the annular space between the casings of each motor in the assembly allowing the stators of each internal motor to rotate. Electricity is conducted to each inner motor through a set of electrically conductive end bearings feeding each inner motor such that multiple bearing sets are necessary for outer motors numbered III and above.

### BRIEF DESCRIPTION OF THE DRAWINGS

FIG. 1a is an exploded view of a typical induction motor.

FIG. 1b is a schematic of the invention showing concentric motor mountings.

FIG. 2 is a photograph of the assembled preferred embodiment.

FIG. 3 is a photograph of the disassembled preferred embodiment.

FIG. 4 is an end view photograph of the preferred embodiment showing the innermost motor.

FIG. 5 is an end view photograph of the output shaft side of the preferred embodiment.

FIGS. 6 and 7 are close-up photographs of the conductive bearing assemblies.

FIG. 8 is another end view photograph of the preferred embodiment output shaft ready for assembly.

FIG. 9 is an internal photograph of the preferred embodiment.

### DETAILED DESCRIPTION OF THE INVENTION

Industrial motors come in a variety of basic types; AC Motors, DC Motors, Brushless DC Motors, Servo Motors, Brushed DC Servo Motors, Brushless AC Servo Motors, Stepper Motors, and Linear Motors The most common and simple industrial motor is the three phase AC induction motor, sometimes known as the “squirrel cage” motor.

The design of the AC motor is simply a series of three windings in the exterior (stator) section with a simple rotating section (rotor). The changing field caused by the 50 or 60 Hertz AC line voltage causes the rotor to rotate around the axis of the motor. The speed of the AC motor depends only on three variables:

1. The fixed number of winding sets (known as poles) built into the motor, which determines the motor's base speed.

2. The frequency of the AC line voltage. Variable speed drives change this frequency to change the speed of the motor.

3. The amount of torque loading on the motor, which causes slip.

Two basic types of motors are designed to operate on polyphase alternating current (AC), synchronous motors and induction motors. The synchronous motor is essentially a three-phase alternator operated in reverse. The field magnets are mounted on the rotor and are excited by direct current, and the armature winding is divided into three parts and fed with three-phase alternating current. The variation of the three waves of current in the armature causes a varying magnetic reaction with the poles of the field magnets, and makes the field rotate at a constant speed that is determined by the frequency of the current in the AC power line. Synchronous motors can be made to operate from a single-phase power source by the inclusion of suitable circuit elements that cause a rotating magnetic field.

The simplest of all electric motors is the squirrel-cage type of induction motor used with a three-phase supply. The armature of the squirrel-cage motor consists of three fixed coils similar to the armature of the synchronous motor. The rotating member consists of a core in which are imbedded a series of heavy conductors arranged in a circle around the shaft and parallel to it. With the core removed, the rotor conductors resemble in form the cylindrical cages once used to exercise pet squirrels. The three-phase current flowing in the stationary armature windings generates a rotating magnetic field, and this field induces a current in the conductors of the cage. The magnetic reaction between the rotating field and the current-carrying conductors of the rotor makes the rotor turn. If the rotor is revolving at exactly the same speed as the magnetic field, no currents will be induced in it, and hence the rotor should not turn at a synchronous speed. In operation the speeds of rotation of the rotor and the field differ by about 2 to 5 percent. This speed difference is known as slip. Motors with squirrel-cage rotors can be used on single-phase alternating current by means of various arrangements of inductance and capacitance that alter the characteristics of the single-phase voltage and make it resemble a two-phase voltage. Such motors are called split-phase motors or condenser motors (or capacitor motors), depending on the arrangement used. Single-phase squirrel-cage motors do not have a large starting torque, and for applications where such torque is required, repulsion-induction motors are used. A repulsion-induction motor may be of the split-phase or condenser type, but has a manual or automatic switch that allows current to flow between brushes on the commutator when the motor is starting, and short-circuits all commutator segments after the motor reaches a critical speed. Repulsion-induction motors are so named because their starting torque depends on the repulsion between the rotor and the stator, and their torque while running depends on induction. Series-wound motors with commutators, which will operate on direct or alternating current, are called universal motors. They are usually made only in small sizes and are commonly used in household appliances.

The speed at which a DC motor operates depends on the strength of the magnetic field acting on the armature, as well as on the armature current. The stronger the field, the slower is the rate of rotation needed to generate a back voltage large enough to counteract the applied voltage. For this reason the speed of DC motors can be controlled by varying the field current.

Equations governing the characteristics of the concentric electric motor drive in the instant invention are:

$${ω}_{output} = {\sum }_{i = 1 - n}^{} {ω}_{i}$$

where:

ωₒᵤₜₚᵤₜ=rotational speed of the output shaft (RPM)

ωᵢ=rotational speed of the individual motor in the drive assembly (RPM)

n=number of energized motors in drive assembly

$${BHP}_{output} = {\sum }_{i = 1 - n}^{} {BHP}_{i}$$

where:

BHPₒᵤₜₚᵤₜ=brake horsepower of the output shaft

BHPᵢ=brake horsepower of the individual motor in the drive assembly

n=number of energized motors in drive assembly

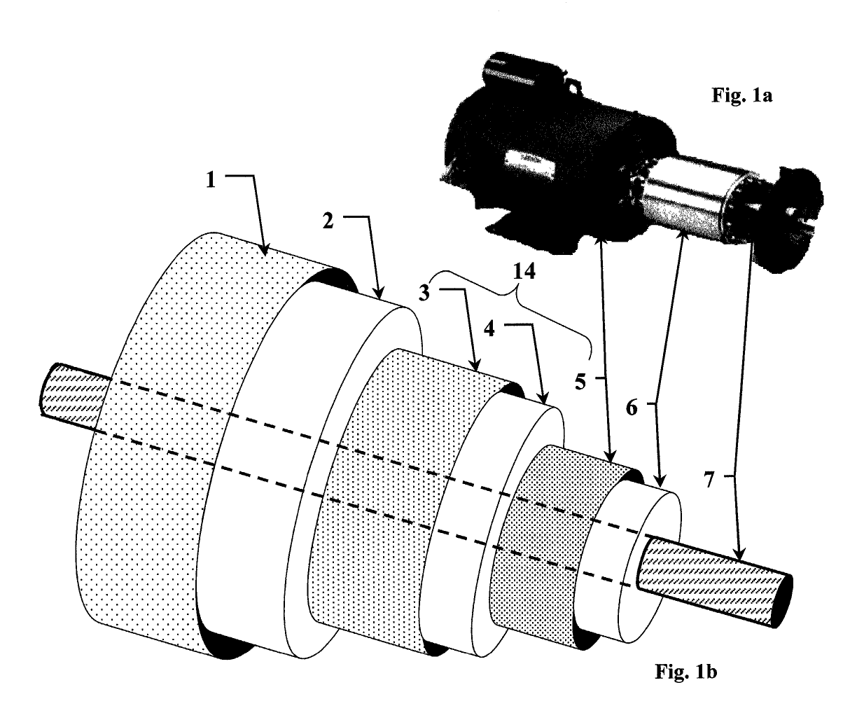

FIG. 1a is a typical electric motor showing the output shaft 7, the rotor 6, and the stator 5. FIG. 1b is a schematic of the instant invention showing multiple electric motors, of incrementally increasing diameter, mounted in an integrated concentric manner such that each internal stator 3 & 5 is removably coupled to rotors 2 & 4, respectively, thereby transmitting the speed and horsepower of each energized motor to the output shaft 7. When the innermost motor is first energized, the output shaft 7 rotates at the nominal speed of the innermost motor. When the next largest stator 3 is energized, the corresponding rotor 4 rotates at its nominal motor speed thereby rotating the removably coupled stator 5 at that nominal speed and the speed of the output shaft 7 is the sum of the speed of rotors 4 and 6. Output horsepower is also summed in the same manner. This assembly can be further extended to as many motors as practically feasible. The electrical feed to all inner stators is routed through conductive end bearings (not shown) of each respective motor.

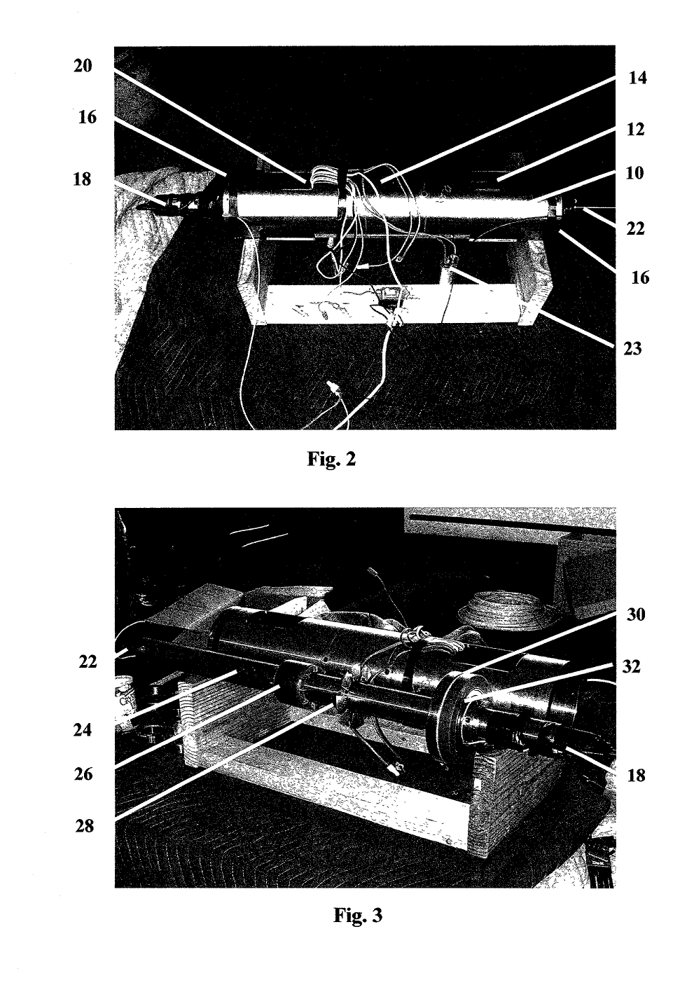

FIGS. 2 and 3 are photographs of the preferred embodiment of the invention; fully assembled in FIG. 2 and with rotor-II core removed in FIG. 3. Casing-II 10, having cooling ports 12, has the stator-II of motor-II 14 removably mounted inside said casing-II 10. Rotor-II 26 was cored out to clear way for removably mounting casing-I 24 inside rotor-II 26 such that casing-I 24 rotates at the speed of rotor-II 26. Cooling fan-II 28 is also removably mounted to casing-II 24 in a similar manner. Conductive end bearings-II 32 were extended radially using a annular donut 30 such that casing-I 24 engages with the inner bearing race and casing-II engages with the outer bearing race allowing rotor-II to rotate freely in operational alignment with stator-II. Removably mounted inside casing-I 24 is motor-I 18, typically referred to as a Dremel motor, and output shaft 22. With motor-II 14 energized, casing-I 24 rotates at the speed of rotor-II 26 thereby rotating stator-I at the same speed. When motor-I 18 is energized, the speed of output shaft 22 is the sum of the speed of motor-I and motor-II. Respective horsepower's are summed in the same manner such that the output horsepower of output shaft 22 is the sum of all energized motor horsepower's. This concentric arrangement can be further extended to many additional motors.

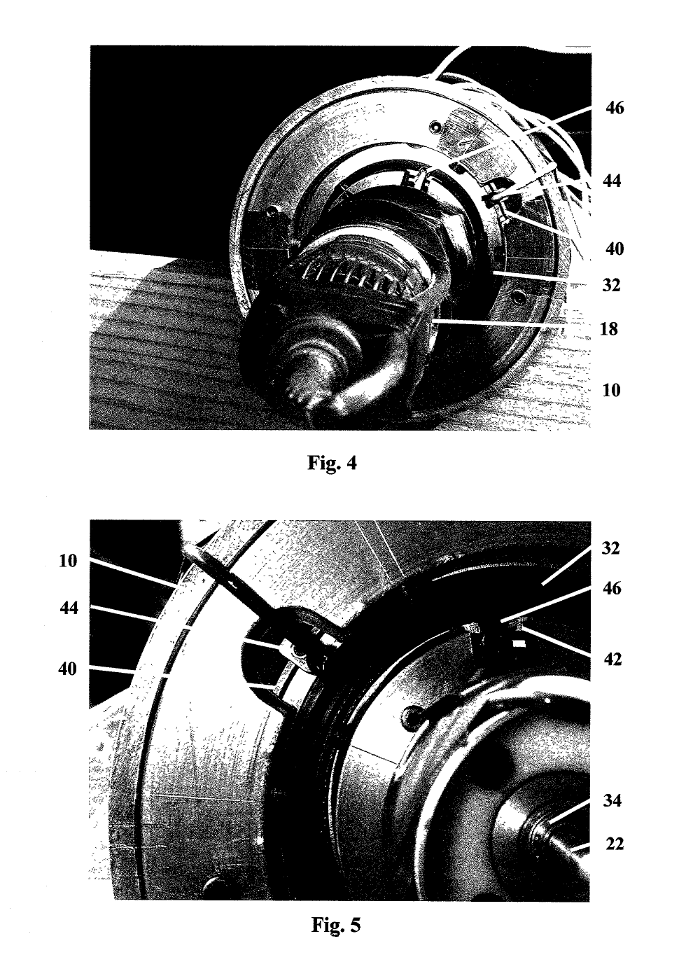

FIGS. 4 and 5 are end-view photographs of the assembled preferred embodiment showing motor-I 18, conductive end bearings-II 32, output shaft 22, casing-II 10, and end bearing-I 34. Conductive end bearings-II 32 have outer sleeve 40 and inner sleeve 42 removably coupled to the outer and inner bearing races of conductive end bearings-II 32 such that electricity is conducted through outer wire connector 44, into outer sleeve 40, into the outer bearing race, through the bearings, into the inner bearing race, into inner sleeve 42, through inner wire connector 46 and on to motor-I 18.

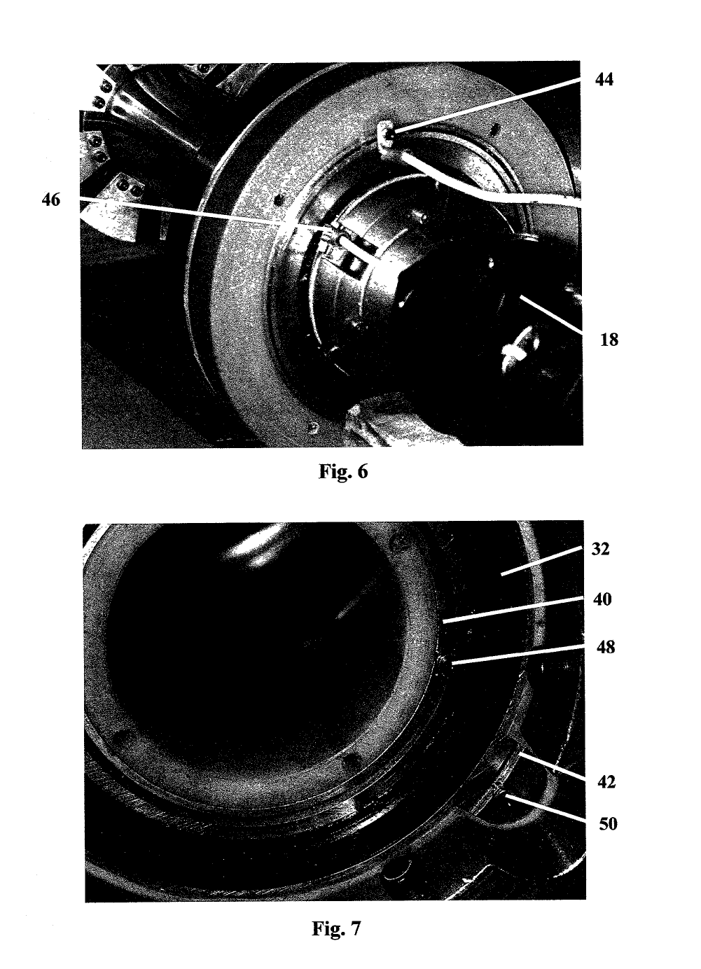

FIGS. 6 and 7 are end views of the unassembled embodiment of the invention with structure elements consistently numbered with previous figures. FIG. 7 shows a clearer view of inner tap screw 48 and outer tap screw 50 removably mounted to inner sleeve 40 and outer sleeve 42, respectively, enabling electrical connection to inner wire connector 46 (not shown) and outer wire connector 44 (not shown), respectively.

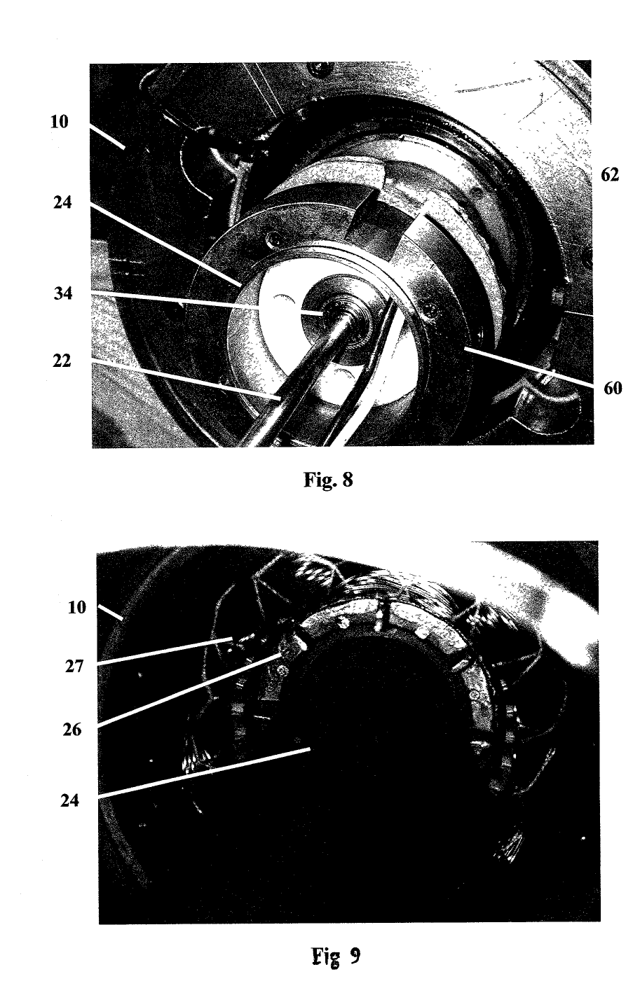

FIG. 8 is a partially assembled end view from the output shaft 22 showing casing-I 24 projecting axially outward with retaining flange-I 60 ready to mount and retaining flange-II 62 already removably mounted with set screws.

FIG. 9 is a photograph inside casing-II 10 showing rotor-II 26 in operational position inside stator-II 27, and casing-I 24 removably mounted inside rotor-II 26 such that casing-I 24 rotates at the speed of rotor-II 26.

This invention is applicable, but not limited, to the following systems:

1) additive or variable-speed motor operation from fixed-frequency three-phase electrical utility mains;

2) additive or variable-speed motor operation from fixed voltage DC power sources;

3) fixed-speed, additive, or variable-speed motor operation with three-phase AC variable-voltage, variable-frequency power supplies;

4) fixed-speed, additive, or variable-speed motor operation from variable voltage DC power sources;

5) additive or variable-speed motor operation from fixed-frequency single-phase electrical utility mains without the need for special starting windings or capacitors; and

6) fixed-speed, additive or variable-speed motor operation with single-phase AC variable-frequency power supplies without the need for special starting windings or capacitors.

As such, the concentric motor drive assembly becomes enabling components for cost effective larger systems, such as:

a) battery or fuel cell powered, all-electric vehicle drive systems;

b) mobile, engine-driven AC auxiliary power sources with controlled output frequency and voltage, decoupled from engine speed;

c) engine or turbine-driven, variable-speed alternator, synchronized to fixed-frequency utility mains, as a co-generation power source,

d) engine-driven, variable-frequency, direct-connected alternator/motor interlink for hybrid vehicle drives,

e) drilling drives for underground and structure penetrating machinery, and

f) milling machine drives for manufacturing machinery or parts.

It will be evident that there are additional embodiments which are not illustrated above, but which are clearly within the scope and spirit of the present invention. The above description and drawings are therefore intended to be exemplary only, and the scope of the invention is to be limited solely by the appended claims and any equivalent elements.

I claim:

1. An electric motor drive assembly comprising:
a) at least two electric motors, having incrementally increasing diameters, mounted in an integrated concentric manner along a common rotational axis, wherein the rotating stator of each internally mounted motor is removably coupled to the rotor of the incrementally larger motor in said assembly; and
b) at least one set of electrically conductive end bearings spanning the annular space between each consecutive motor casing in said assembly.

2. The electric motor drive assembly of claim 1 wherein said electric motors are selected from the group consisting of AC motors, DC motors, brushless DC motors, servo motors, brushed DC servo motors, brushless AC servo motors, stepper motors, and linear motors.

3. The electric motor drive assembly of claim 1 wherein each said set of electrically conductive end bearings communicates current to one predetermined stator in said drive assembly.

4. The electric motor drive assembly of claim 1 wherein the electric power source to each motor is selected from at least one of the group consisting of fixed frequency electrical utility mains, fixed voltage DC power, variable frequency AC power source, and variable voltage DC power source.

5. A method for varying the output speed of a concentric multiple electric motor drive comprising:
a) energizing the innermost motor through a set of electrically conductive end bearings to rotate the output shaft at a first nominal speed,
b) energizing the second innermost motor through a set of electrically conductive end bearings to rotate the stator of said innermost motor at the speed of the second innermost motor thereby rotating said output shaft at the sum of both motor speeds,
c) energizing each incrementally larger motor in said motor drive through a set of electrically conductive end bearings thereby incrementally adding speed and horsepower to said output shaft.

6. The method of claim 5 wherein said electric motors are selected from the group consisting of AC motors, DC motors, brushless DC motors, servo motors, brushed DC servo motors, brushless AC servo motors, stepper motors, and linear motors.

7. The method of claim 5 wherein each said set of electrically conductive end bearings communicates current to one predetermined stator in said drive assembly.

8. The electric motor drive assembly of claim 1 wherein the electric power source to each motor is selected from at least one of the group consisting of fixed frequency electrical utility mains, fixed voltage DC power, variable frequency AC power source, and variable voltage DC power source.
